(19) United States
(12) Patent Application Publication
(10) Pub. No.: US 2026/0015030 A1
(43) Pub. Date: Jan. 15, 2026

(54) STEERING COLUMN FOR A MOTOR VEHICLE

(71) Applicants: thyssenkrupp Presta AG, Eschen (LI); thyssenkrupp AG, Essen (DE)

(72) Inventors: Philip MELSA, Dornbirn (AT); Thomas Werner HEITZ, Mauren (LI)

(73) Assignees: thyssenkrupp Presta AG, Eschen (LI); thyssenkrupp AG, Essen (DE)

(21) Appl. No.: 19/253,210

(22) Filed: Jun. 27, 2025

(30) Foreign Application Priority Data
Jul. 12, 2024 (BE) BE 2024/5452

(51) Int. Cl. B62D 1/16

(52) U.S. Cl. CPC B62D 1/163

(57) ABSTRACT

A steering column for a motor vehicle comprises a steering shaft that is mounted so as to be rotatable about its longitudinal axis relative to a housing, and a rotation limiter which is designed to limit the rotation of the steering shaft relative to the housing and has a flexibly deformable belt element which is fixed to the housing, is elongate in a belt direction, extends in a flat manner transversely thereto in terms of its belt width, is able to be wound on a winding core connected to the steering shaft, and comprises a fabric made of plastics fibres which comprise warp threads extending in the belt direction which are woven together with weft threads extending transversely to the belt direction. In order to allow improved functional and operating properties of the rotation limiter, the warp threads may comprise first warp threads which comprise a first polymer material and second warp threads which comprise a second polymer material.

### CROSS REFERENCE TO RELATED APPLICATION

This application is a U.S. Non-Provisional that claims priority to Belgian Patent Application No. BE 2024/5452, filed Jul. 12, 2024, the entire content of which is incorporated herein by reference.

### FIELD

The present disclosure relates to a steering column for a motor vehicle.

### BACKGROUND

In a steer-by-wire steering system, the manual rotation of the steering shaft for inputting a steering command is sensed by means of a rotation sensor, which has at least one rotation angle sensor and/or torque sensor, and is converted into an electrical signal for actuating electric steering actuators. Since, unlike in a conventional steering system, the steering shaft is not mechanically coupled to the wheels, the rotation of the steering shaft is not limited by the mechanical end stop of the wheels upon reaching the maximum steering angle. In order, nevertheless, to avoid steering too far and also to simulate a realistic steering sensation, provision is made, in systems of the generic type, to limit the maximum possible steering angle of the steering wheel by means of a rotation limiter. This forms a limiting device with an end stop for limiting the maximum possible rotation of the steering shaft.

A steering column of the generic type is known from DE 10 2021 201 640 A1, having a steering shaft that is rotatably mounted in a housing, the steering column housing. Said steering shaft has a rotation limiter with a flexible belt element that is elongate in a flat manner in a belt direction and is able to be wound on a winding core which is connected to the steering shaft. In a non-wound belt portion that protrudes from this winding core, the belt element is fixed to the housing in a high-tensile manner in the belt direction, i.e. in its longitudinal direction. The function provides that the belt element can be wound on the winding core through a defined rotation angle of the steering shaft relative to the housing, which may generally comprise several revolutions, until the free belt portion is tightly stretched between the winding core and the housing. This stops further winding on, and a rotation limiter is realized. The winding on in both possible directions of rotation means that symmetric rotation limiting can be effected.

Advantages of the rotation limiter of the generic type are the reliable operation, the flexible design with regard to the possible range of rotation, and the compact structure. In order to realize this, the belt element has to meet stringent demands. Thus, a high specific tensile strength is necessary in order to be able to reliably absorb the high tensile force acting on the stop in conjunction with as small a belt cross section as possible. At the same time, there has to be a high level of flexibility in conjunction with low elasticity transversely to the longitudinal extent, i.e. low flexural rigidity, in order that the belt element is able to be wound on the winding core uniformly and without noticeable elastic restoring forces within the entire possible range of rotation. Furthermore, it is particularly important for the belt element to remain dimensionally stable throughout the lifetime of the vehicle, and in particular, as a result of the temperature fluctuations and load changes that arise during operation, not to undergo any changes in length which would immediately generate an unacceptable change in the range of rotation.

It is known practice to produce the belt element from a fabric comprising plastics fibres which comprise warp threads extending in the belt direction, which are woven together with weft threads extending transversely to the belt direction. The use thereof in a rotation limiter requires the compliance with the abovementioned, clearly defined properties of the belt element, which have to be met with close tolerances throughout the lifetime of the vehicle. It is essential that, as far as possible, no change in the belt length occurs, this being correlated directly with the rotation angle or limiting angle.

However, during operation, considerable temperature fluctuations and extreme loads act on the belt, and these result, in the case of a basic use of previously known plastics, even of extremely loadable high-performance polymers, in disadvantageous structural deterioration, which may result in unacceptable shortening.

Thus a need exists to allow improved functional and operating properties of the rotation limiter.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a steering column according to the invention in a schematic perspective view.

FIG. 2 shows the steering column according to FIG. 1 in a further perspective view.

FIG. 3 shows a portion of a belt element according to the invention.

FIG. 4 shows a schematic, enlarged detail view of the belt element according to the invention according to FIG. 3.

FIG. 5 shows a schematic, perspective view of the fabric of the belt element according to FIG. 3.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to a steering column for a motor vehicle, comprising a steering shaft that is mounted so as to be rotatable about its longitudinal axis relative to a housing, and a rotation limiter which is designed to limit the rotation of the steering shaft relative to the housing and has a flexibly deformable belt element which is fixed to the housing, is elongate in a belt direction, extends in a flat manner transversely thereto in terms of its belt width, is able to be wound on a winding core which is connected to the steering shaft, and comprises a fabric made of plastics fibres which comprise warp threads extending in the belt direction which are woven together with weft threads extending transversely to the belt direction.

In the case of a steering column for a motor vehicle, comprising a steering shaft that is mounted so as to be rotatable about its longitudinal axis relative to a housing, and a rotation limiter which is designed to limit the rotation of the steering shaft relative to the housing and has a flexibly deformable belt element which is fixed to the housing, is elongate in a belt direction, extends in a flat manner transversely thereto in terms of its belt width, is able to be wound on a winding core connected to the steering shaft, and comprises a fabric made of plastics fibres which comprise warp threads extending in the belt direction which are woven together with weft threads extending transversely to the belt direction, the invention provides that the warp threads comprise first warp threads which comprise a first polymer material and second warp threads which comprise a second polymer material.

According to the definition, the belt element has a belt length in its belt direction and, transversely thereto, a belt width which is less than the belt length. The belt element is in the form of a flat belt element, which has a much smaller belt thickness perpendicularly to the belt length and belt width, said belt thickness corresponding to a fraction of the belt width.

According to the invention, the belt element is made from a hybrid fabric. According to the definition, this has warp threads that extend in the belt direction and are made of two different polymers with different, specific functional properties. Put another way, a hybrid belt is produced from a hybrid fabric which comprises warp threads that extend in the belt direction and are made of specific, different plastics.

The specific properties of the belt that are necessary for the use according to the invention in a rotation limiter are determined primarily by the warp threads extending in the longitudinal direction. During operation, the belt is exposed to high, alternating tensile loads with pulse-like load peaks, and at the same time to high bending stresses during winding and unwinding. In addition, there is thermal stress. In this case, it is essential that the properties of the belt remain as constant as possible in continuous operation over the lifetime of the steering column. In particular, a reduction in the tensile strength and a change in length, which could result in the limiting function being impaired, have to be reliably precluded.

According to the invention, at least two different types of warp threads are used, which are made from different polymer materials which each have different defined material properties adapted specifically to the requirements in a rotation limiter. Potential conflicts of objectives which cannot be solved by the use of a single polymer, for example high endurance tensile strength at the same time as high thermal and dimensional stability and low brittleness, can be solved optimally according to the invention by separate polymer materials optimized specifically with regard to the individual requirements. As a result of differently optimized materials being combined according to the invention in a hybrid arrangement, i.e. in a hybrid belt according to the invention, the different properties of the different polymer materials can be used synergistically. In this case, the specific properties of one polymer material can virtually entirely compensate for potential specific weaknesses of the other polymer material. Furthermore, as a result of the synergistic collaborations, advantageous operating properties of the belt can be achieved, which advantageously go beyond the simple addition of the different material properties. As a result, maximum operational reliability can be realized.

A further advantage is that the hybrid belt according to the invention, while having the same loadability, can have smaller dimensions than the known designs, i.e. in particular a smaller thickness and/or belt width. As a result, a lighter and more compact structure can be realized.

It is possible for the warp threads each to be in the form of fibres made from a single continuous polymer material. Furthermore, it may be advantageous for further materials to be embedded in the matrix of the polymer material, in order to form a polymer-based composite material. For example, reinforcing elements in the form of carbon fibres, nanotubes or the like can be added to the polymer. As a result, further function optimization is possible.

It is particularly advantageous that the warp threads comprise first warp threads made of a high molecular weight polymer and second warp threads made of a liquid crystal polymer.

A high molecular weight polymer (HMW polymer) has, according to the definition, an average molecular weight of about 500 to 1000 kg/mol or higher. In the case of a higher molecular weight of up to 6000 kg/mol, the expression ultra-high molecular weight polymer (UHMW polymer) is used.

A liquid crystal polymer (LCP) has a rod-like molecular form which is maintained even in a liquid state. It is characterized by high strength, dimensional stability and temperature stability while having a relatively low density.

Specifically, the first warp threads made of a high molecular weight polymer provide the required high strength, while the second warp threads made of a liquid crystal polymer ensure high thermal stability and high dimensional stability of the belt element.

The combination according to the invention brings about a synergistic enhancement of the abovementioned positive properties of the two polymer materials, wherein the potentially disadvantageous properties, for example the lower dimensional stability, potentially bringing about shortening, of the high molecular weight polymer and the potential brittleness of the liquid crystal polymer under frequent buckling load, are effectively compensated by the combination according to the invention.

In this way, advantageously high operational reliability and functional properties of the belt element and thus of the rotation limiter that remain constant over the lifetime are ensured by the combination according to the invention.

Preferably, provision may be made for the high molecular weight polymer to comprise an ultra-high molecular weight polyethylene. Ultra-high molecular weight polyethylene, also known as UHMW-PE, is an extremely long-chain thermoplastic polyethylene with a molecular weight of between about 2.5 and 7.5 million amu (atomic mass units). It has extremely high strength and abrasion resistance, which is up to 15 times higher than that of carbon steel, and a low coefficient of friction, which is comparable with polytetrafluorethylene (PTFE, trade name: Teflon®).

Furthermore, it has an extremely low moisture absorption rate, which ensures that no significant changes to the properties and dimensions occur during operation.

Provision may be made for the liquid crystal polymer to comprise an aromatic polyamide or an aromatic polyester. The liquid crystal polymer can preferably be chosen appropriately in relation to the properties of the high molecular weight polymer. In any case, it has high temperature and dimensional stability over the entire lifetime, thereby ensuring that no shortening of the belt element occurs.

It is possible for first warp threads made of exactly one high molecular weight polymer and second warp threads made of exactly one liquid crystal polymer to be used. This makes the structured provision of a hybrid fabric according to the invention having defined properties simpler. Furthermore, however, it is also conceivable and possible to use more than one high molecular weight polymer and/or liquid crystal polymer, specifically in first and second warp threads, or alternatively in third or further different warp threads.

Preferably, the proportion of the first warp threads relative to the proportion of the second warp threads is specified in a defined manner. For example, a ratio of 1:1 can be realized, where the number of the first and second warp threads is identical or at least substantially identical. It is also possible, however, to realize different ratios, which, with regard to a synergistic action, are optimized in relation to compensation of the specific advantages and disadvantages of the two polymers.

Provision may preferably be made for a plurality of first warp threads to be arranged alongside one another transversely to the belt direction in alternation with second warp threads. The relative number of the first and second warp threads can be specified to specify defined properties of the belt element, for example via an alternating arrangement in a ratio in a range between 7:10 and 13:10.

Preferably, the first and second warp threads are each in the form of fibre strands made up of a plurality of fibres. As a result, the flexibility and buckling resistance can be optimized.

Advantageously, the weft threads are made from a polymer material different from the plastic of the warp threads. The weft threads woven together with the first and second warp threads may be made from a single polymer, preferably from a thermoplastic polymer, for example polyester or the like. Provision may preferably be made for the fabric to comprise a twill weave, for example a 2/2 twill weave. This is characterized in that a weft thread extends in each case above two warp threads and then below two following warp threads, wherein successive weft threads are each offset by one warp thread with respect to one another.

In the various figures, identical parts are always provided with the same reference signs and are therefore generally also each mentioned only once.

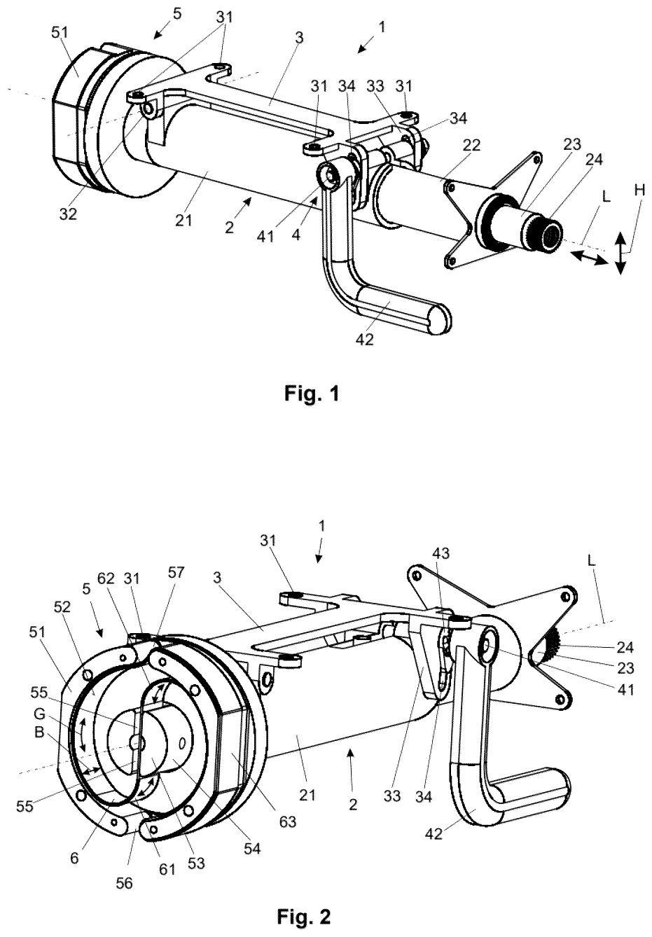

FIGS. 1 and 2 show, in different perspective views, a steering column 1 of a steer-by-wire steering system, from the rear left in FIG. 1 and from the front left in FIG. 2, in each case with respect to the direction of travel.

The steering column 1 comprises an actuator 2, which has a housing, namely a steering column housing 21, which is also referred to as a casing unit or outer casing tube. Accommodated in the steering column housing 21 is a casing tube 22, in which a steering shaft 23 is mounted so as to be rotatable about the longitudinal axis L. At the rear end, with regard to the direction of travel, facing the driver, the steering column 23 has a connection portion 24 for attached a steering wheel (not illustrated here). To longitudinally adjust the steering wheel, the casing tube 22 is telescopically adjustable in the direction of the longitudinal axis L relative to the steering column housing 21, as is indicated by the double arrow parallel to the longitudinal axis L.

The actuator 2 is held by a supporting unit 3, which has fastening openings 31 for attaching to a body (not illustrated) of a motor vehicle. In a front region, the steering column housing 21 is mounted on the supporting unit 3 so as to be pivotable about a horizontal pivot pin 32 transverse to the longitudinal axis L, thereby allowing vertical adjustment of the rear, driver-side end of the steering column 23 in the vertical direction H.

The supporting unit 3 has, at a distance towards the rear from the pivot pin 32, two side plates 33, which extend downward parallel to one another and between which the steering column housing 21 is accommodated.

A clamping device 4 comprises a clamping bolt 41, which is guided through slots 34, extending in the vertical direction H, through the two side plates 33. Fastened to the clamping bolt 41 is a clamping lever 42, with which the clamping bolt 41 can be rotated manually about its axis.

The clamping device 4 has a clamping gear 43, which converts a rotation of the clamping bolt 41 about its axis into a clamping travel in the direction of its axis, for example by means of a V-pulley device, cam device or tilting pin device known per se. The clamping pin 41 is supported from outside against the two side plates 33 via the clamping gear 43. If the clamping bolt 41 is rotated into the clamping or fixing position by manual actuation of the clamping lever 42 in one direction, the two side plates 33 are pushed together, and as a result the steering column housing is clamped between the side plates 33, and as a result is fixed in the vertical direction H relative to the supporting unit 3. In the process, the casing tube 22 is also braced in the steering column housing 21, such that fixing likewise occurs in the direction of the longitudinal direction L.

If the clamping lever 42 is moved into the release position by rotation in the opposite direction, the clamping travel is reversed, and the clamping of the steering column housing 21 between the side plates 33 is released. The clamping bolt 41 can then be moved up or down in the vertical direction H in the slots 34 together with the steering column housing 21 for vertical adjustment, and the casing tube 22 can be pushed telescopically forward into the steering column housing 21 or pulled out towards the rear in the direction of the longitudinal axis L for longitudinal adjustment.

A rotation limiter 5 designed according to the invention is attached to the front of the steering column 1. Said rotation limiter is illustrated in a forwardly open manner in a perspective view in FIG. 2, in order to open up a view into the interior. The rotation limiter 5 is closable with a cover (not illustrated).

The rotation limiter 5 has a housing in the form of a drum 51, which forms a part of the steering column housing 21, with which it is formed in one piece, or to which it is fixedly connected. The drum 51 is hollow cylindrical, having an inner casing 52, which is arranged coaxially with the longitudinal axis L.

Arranged in the drum 51 is a winding core 53, which is fixedly connected to the steering shaft 23 and has a cylindrical outer casing 54 coaxial with the longitudinal axis L.

The outside diameter of the outer casing 54 is preferably less than or equal to 0.5 times the inside diameter of the inner casing 52.

The winding core 53 has a diametrically continuous transverse slot 55 transverse to the longitudinal axis L, which is axially open towards the front. The transverse slot 55 opens diametrically on the opposite side into the outer casing 54.

The drum 51 has two transverse slots 56, 57 that are diametrically opposite one another with respect to the longitudinal axis L and form passages from the inner casing 52 to the outer side of the drum 51, and are likewise axially open on the end side.

A belt element 6, which is in the form of a closed loop, is fitted between the winding core 53 and the drum 51, as is apparent from FIG. 2. The belt element 6 is a highly flexible, flat band with a belt width which matches the axial width of the outer casing 54 and which also corresponds approximately to the axial width of the inner casing 52.

The belt element 6 comprises a fabric according to the invention, which is explained in more detail below and is highly flexible, i.e. non-rigid such that when it is bent during winding or unwinding transversely to its longitudinal extent and to its width, no elastic restoring force or only a negligible restoring force occurs.

The belt element 6 has been passed through the transverse slot 55 in the winding core 53 transversely to the longitudinal axis L, wherein the transverse slot 55 is provided with an insertion bevel in order to effectively prevent the belt element 6 from being damaged. As a result, the belt element 6 is connected to the winding core 53 for conjoint rotation. The band portion 61 extending radially out of the winding core 53 on one side extends through the one transverse slot 56 to the outer side of the drum 51, and the band portion 62 extending radially out of the winding core 53 on the other side extends through the other transverse slot 57 to the outer side of the drum 51. The band portions 61 and 62 are connected together as a closed loop by a band portion 63 passing around the outside of the drum 51. As a result, the belt element 6 is fixed in the circumferential direction with regard to the inner casing 52.

The belt element 6 extends as a belt band along its length in the belt direction G, which is schematically indicated in FIG. 2 by the double arrows lying in the longitudinal direction. Transversely thereto, the belt element 6 has a belt width B (likewise indicated by a double arrow in FIG. 2). Thus, the belt element 6 extends two-dimensionally parallel to the belt direction G and to the belt width B.

The belt element 6 is flexible perpendicularly to the belt direction G and to the belt width B, with low elasticity, i.e., put another way, is non-rigid. As a result, virtually no restoring forces or moments act on the steering shaft 23 during winding onto the winding core 53.

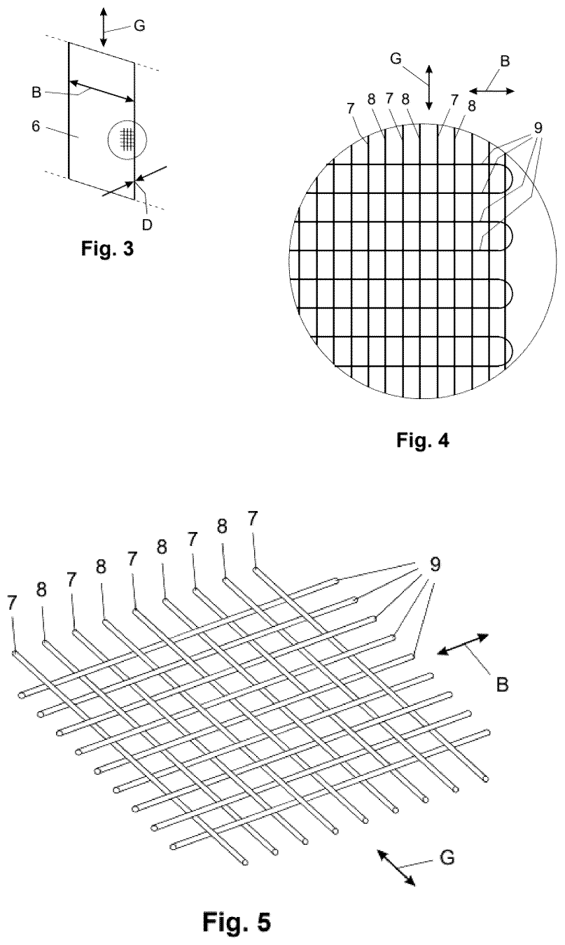

FIG. 3 shows a longitudinal portion of the belt element 6. Therein, the belt thickness D is also indicated, which has a much smaller belt thickness D perpendicularly to the belt length extending in the belt direction G and to the belt width B, said belt thickness corresponding to a fraction of the belt width B.

In FIG. 4, the detail, circled in FIG. 3, of the fabric is illustrated in a greatly enlarged manner in a plan view normal to its two-dimensional extent, i.e. perpendicularly to the belt direction G and belt width B. In this case, the fabric structure is schematically illustrated.

The fabric has first warp threads 7 and second warp threads 8 extending in the belt direction G, which are arranged transversely, in the direction of the belt width B, alternately alongside one another.

The warp threads 7, 8 are woven together with weft threads 9 extending transversely to the belt direction G, i.e. in the direction of the belt width B.

A 2/2 twill weave may have been realized, as is illustrated in the partial schematic perspective view of a fabric detail according to FIG. 5.

According to the invention, the first warp threads 7 are made from a high molecular weight polymer, preferably an ultra-high molecular weight polyethylene (UHMW-PE), and the second warp threads 8 are made from a liquid crystal polymer. Both types of warp threads 7 and 8 are preferably each in the form of fibre strands made up of a multiplicity of individual threads. As a result, particularly high flexibility and a low elastic restoring action upon bending transversely to the two-dimensional extent can be realized.

The weft threads 9 may be in the form of fibres or fibre strands made of polyethylene.

### LIST OF REFERENCE SIGNS

1 Steering column
2 Actuator
21 Steering column housing
22 Casing tube
23 Steering shaft
24 Connection portion
3 Supporting unit
31 Fastening openings
32 Pivot pin
33 Side plates
34 Slot
4 Clamping device
41 Clamping bolt
42 Clamping lever
43 Clamping gear
5 Rotation limiter
51 Drum
52 Inner casing
53 Winding core
54 Outer casing
55 Transverse slot
56, 57 Transverse slots
6 Belt element
61, 62 Band portions
63 Band portion
7 First warp threads
8 Second warp threads
9 Weft threads
L Longitudinal axis
H Vertical direction
G Belt direction
B Belt width
D Belt thickness

1. A steering column for a motor vehicle, comprising:
a steering shaft mounted so as to be rotatable about its longitudinal axis relative to a housing; and
a rotation limiter designed to limit rotation of the steering shaft relative to the housing and that has a flexibly deformable belt element fixed to the housing, is elongate in a belt direction, extends in a flat manner transversely to the belt direction in terms of its belt width, is able to be wound on a winding core connected to the steering shaft, and comprises a fabric made of plastics fibres which include warp threads extending in the belt direction which are woven together with weft threads extending transversely to the belt direction;
wherein the warp threads include first warp threads comprising a first polymer material and second warp threads comprising a second polymer material.

2. The steering column according to claim 1, wherein the warp threads include first warp threads made of a high molecular weight polymer and second warp threads made of a liquid crystal polymer.

3. The steering column according to claim 2, wherein the high molecular weight polymer comprises an ultra-high molecular weight polyethylene.

4. The steering column according to claim 3, wherein the liquid crystal polymer comprises an aromatic polyamide or an aromatic polyester.

5. The steering column according to claim 1, wherein a plurality of first warp threads are arranged alongside one another transversely to the belt direction in alternation with second warp threads.

6. The steering column according to claim 1, wherein the relative number of first and second warp threads is in a ratio of between 7:10 and 13:10.

7. The steering column according to claim 1, wherein the warp threads are each in the form of fibre strands made up of a plurality of fibres.

8. The steering column according to claim 1, wherein the weft threads are made from a polymer material different from the plastic of the warp threads.

9. The steering column according to claim 1, wherein the weft threads are made from polyester.

10. The steering column according to claim 1, wherein the fabric comprises a twill weave.
